(19) United States
(12) Patent Application Publication
(10) Pub. No.: US 2019/0036259 A1
(43) Pub. Date: Jan. 31, 2019

(54) FEMALE TERMINAL

(71) Applicant: Sumitomo Wiring Systems, Ltd., Yokkaichi (JP)

(72) Inventor: Takamaru Amano, Yokkaichi (JP)

(21) Appl. No.: 16/037,027

(22) Filed: Jul. 17, 2018

(30) Foreign Application Priority Data
Jul. 31, 2017 (JP) 2017-148045

(51) Int. Cl. H01R 13/11

(52) U.S. Cl. CPC H01R 13/113; H01R 13/4223

(57) ABSTRACT

A female terminal (10) to be connected to a male terminal (40) including a male-side body (41) extending in a front-rear direction and includes a female-side body (11) configured so that the male-side body (41) is inserted therein from the front. A resilient contact piece (23) is configured to resiliently contact the male-side body (41) in a first direction intersecting a connecting direction of the male terminal (40), and a receiving portion (16) configured to contact the male-side body (41) in second direction opposite to the first direction. A receiving-side contact (19) forms a contact point between the receiving portion (16) and the male-side body (41) is located forward of a contact piece-side contact point (27) serving as a contact point between the resilient contact piece (23) and the male-side body (41).

### BACKGROUND

### Field of the Invention

This specification relates to a female terminal.

### Related Art

Japanese Unexampled Patent Publication No. 2008-117650 discloses a female terminal that includes a rectangular tubular fitting extending in a front-rear direction, a wire connecting portion behind the tubular fitting and a coupling that couples the tubular fitting and the wire connecting portion.

The wire connecting portion is in the form of an open barrel and is crimped to a core of a wire by crimping. The tubular fitting includes a horizontal base plate serving as a bottom surface, a horizontal receiving plate serving as an upper surface and left and right side plates substantially at a right angle to the base plate and the receiving plate.

A resilient contact is folded rearward from a front end of the base plate and is cantilevered into the tubular fitting. The resilient contact piece is struck at a highest position so that the upper surface thereof projects into a dome shape to form a contact point.

A contact surface is formed by striking a part of the receiving plate down toward the resilient contact piece substantially in parallel to the receiving plate. Thus, a lower surface of the receiving plate facing the resilient contact forms a horizontal flat contact surface.

A mating male terminal, as a connection partner of the terminal fitting, has a tab in the form of a horizontal plate long and narrow in the front-rear direction.

When the terminal fitting and the mating terminal are connected, the tab of the mating terminal is inserted between the resilient contact piece of the terminal fitting and the contact portion of the receiving plate. At this time, the contact point of the resilient contact piece resiliently contacts a lower surface of the tab of the mating terminal from below. In this way, an upper surface of the tab of the mating terminal comes into contact with the contact surface of the receiving plate.

If a voltage is applied to the mating terminal with the terminal fitting and the mating terminal connected, a current flows from the tab of the mating terminal to the terminal fitting through the contact point of the resilient contact piece and a contact point between the contact surface of the receiving plate and the tab.

However, a lower surface of the receiving plate of the terminal fitting is flat. Thus, if the terminal fitting and the mating terminal are connected, the receiving plate and the tab are held in surface contact. However, if a force is applied to the tab due to vibration or the like to incline the tab, the tab and the contact portion of the receiving plate are held in point contact. At this time, a contact point position differs depending on a degree of inclination of the tab, and there is a problem that the contact point position between the tab and the contact portion of the receiving plate is not determined. Further, a female terminal fitting and a male mating terminal generally are made of different materials, and the female terminal fitting has a higher conductivity than the male mating terminal. Thus, a path of a current flowing in the tab becomes longer if the contact point position between the tab and the contact portion of the receiving plate is located forward of the contact point portion of the resilient contact piece (closer to the tip of the tab) than in the case where the contact point position is located rearward of the contact point portion. This causes a problem of increasing resistance between the terminals.

### SUMMARY

A female terminal disclosed in this specification is to be connected to a male terminal including a male-side body extending in a front-rear direction. The female terminal includes a female-side body configured so that the male-side body is inserted therein from the front. A resilient contact piece is configured to achieve resilient contact with the male-side body in a first direction intersecting a connecting direction to the male terminal, and a receiving portion is configured to contact the male-side body in a second direction opposite to the first direction. A receiving-side contact point is located forward of a contact piece-side contact that functions as a contact point between the resilient contact piece and the male-side body to form a contact point between the receiving portion and the male-side body. By adopting this configuration, the receiving-side contact point is forward of the contact piece-side contact. Thus, as compared to a conventional configuration in which a receiving-side contact point portion is rearward of a contact piece-side contact point, a path of a current flowing in the male-side body becomes shorter and resistance between the male and female terminals can be reduced.

The female-side body may include an opening, and the male-side body is inserted through the opening. The resilient contact piece may include a folded portion cantilevered from a front of the opening and folded rearward. The folded portion may have a bead projecting in the second direction, and the contact piece-side contact point may be provided on the bead. With this configuration, a contact point between the resilient contact piece and the male-side body is determined on the bead and a contact point position becomes clear.

The receiving portion may include a front inclined portion located forward of the receiving-side contact point. The front inclined portion may have a chevron shape projecting in the second direction. A rear inclined portion may be located on a rear side and may be inclined in the second direction. The front inclined portion may be inclined more steeply than the rear inclined portion and the receiving-side contact point portion may be provided on the opening side of the female-side body. With this configuration, the receiving-side contact point is positioned on the opening side. Thus, the path of the current flowing in the male-side body can be made shorter.

Plural receiving portions may be disposed in parallel in a width direction in the female-side body. With this configuration, contact resistance between the male and female terminals can be reduced. Further, by increasing the number of contact points between the male-side body and the receiving portion, the male-side body can be prevented from becoming shaky in the female-side body.

Accordingly, it is possible to suppress resistance between male and female terminals by shortening a path of a current flowing in the male terminal having a low conductivity and extending a path of a current flowing in the female terminal having a high conductivity.

### BRIEF DESCRIPTION OF DRAWINGS

FIG. 1 is a section when a female housing and a male housing are connected straight in a first embodiment.

FIG. 2 is a section when the female housing and the male housing are connected obliquely in the first embodiment.

FIG. 3 is a section of a female terminal in the first embodiment.

FIG. 4 is a section along A-A of FIG. 3 in the first embodiment.

FIG. 5 is a section, corresponding to FIG. 4 of the first embodiment, but showing a receiving portion in a second embodiment when viewed from below.

FIG. 6 is a section, corresponding to FIG. 4 of the first embodiment, but showing a receiving portion in a third embodiment when viewed from below.

FIG. 7 is a section, corresponding to FIG. 4 of the first embodiment, but showing a receiving portion in a fourth embodiment when viewed from below.

FIG. 8 is a section of a female terminal in reference example 1.

FIG. 9 is a section along B-B of FIG. 8 in reference example 1.

FIG. 10 is a section of a female terminal in reference example 2.

FIG. 11 is a section along C-C of FIG. 10 in reference example 2.

### DETAILED DESCRIPTION

### First Embodiment

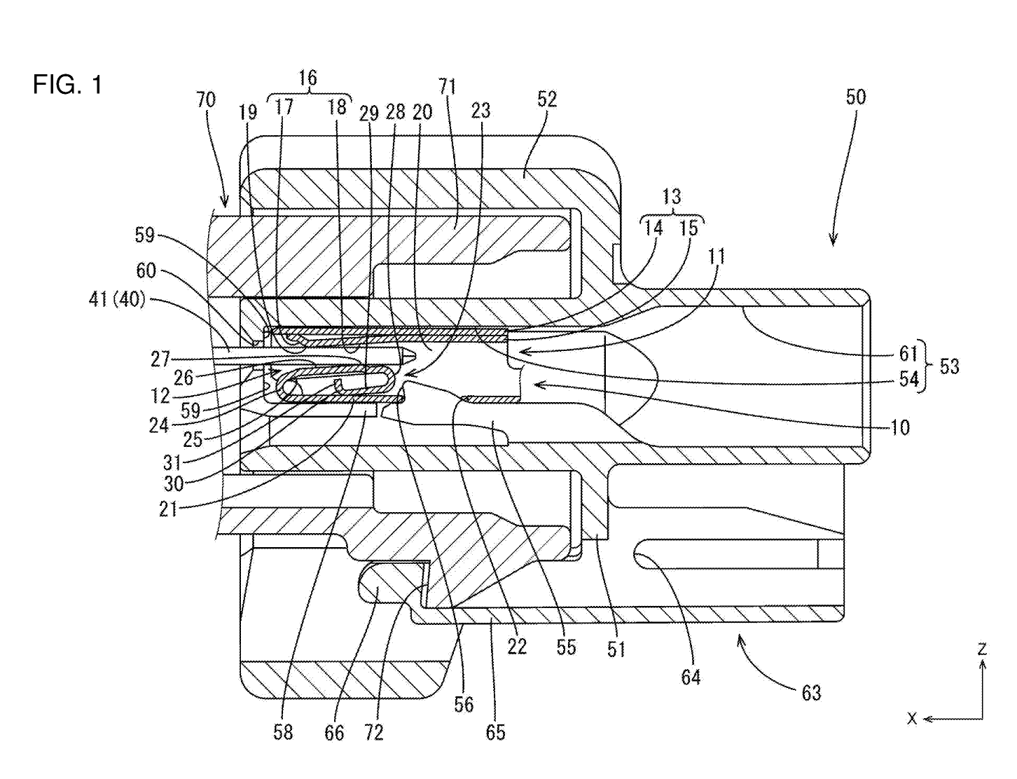

A first embodiment is described with reference to FIGS. 1 to 4. A female terminal 10 of this embodiment is used by being accommodated in a female housing 50 as shown in FIG. 1. The female housing 50 is connected to a male housing 70 accommodating a male terminal 40 therein. The female terminal 10 and the male terminal 40 are connected when the female housing 50 and the male housing 70 are connected. In the following description, an X direction, a Z direction and a Y direction in FIGS. 1 to 4 are referred to as a forward direction, an upward direction and a rightward direction.

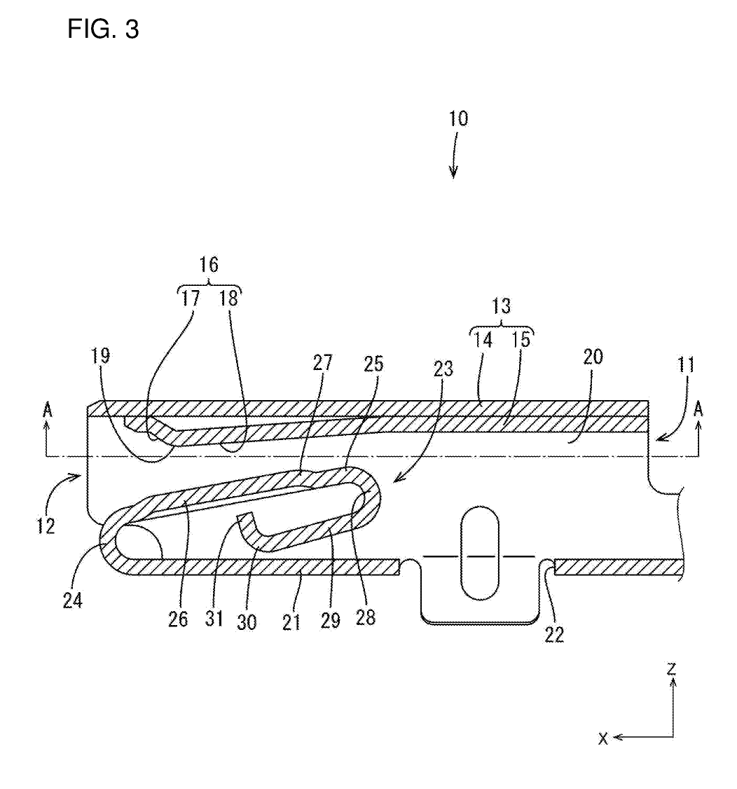

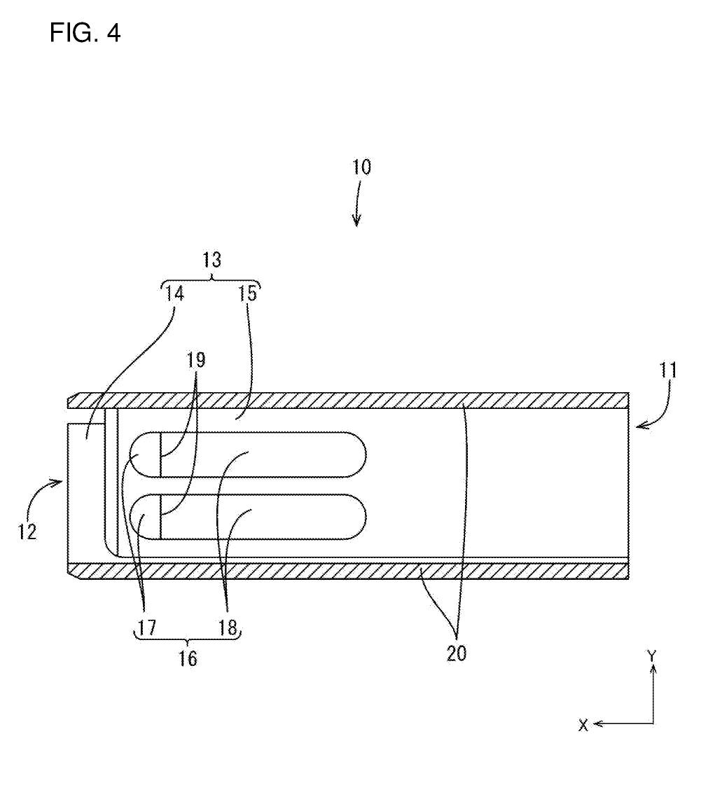

The female terminal 10 is formed by press-working and bending a metal plate and includes a female-side body 11 in the form of a rectangular tube open in a front-rear direction, as shown in FIGS. 3 and 4. The female-side body 11 includes a ceiling 13 on an upper side, a bottom wall 21 on a lower side, two side walls 20 coupling sides of the ceiling 13 and those of the bottom wall 21, and a resilient contact piece 23.

As shown in FIG. 3, the ceiling 13 has an upper ceiling wall 14 on an upper side and a lower ceiling wall 15 on a lower side placed one on top of the other. Receiving portions 16 having a chevron shape project down on a front part of the lower ceiling wall 15. As shown in FIG. 4, two receiving portions 16 are disposed in parallel in a lateral direction. A top of the receiving portion 16 serves a receiving-side coupling portion 19 configured to contact a male-side body 41 to be described later. As shown in FIG. 3, the receiving portion 16 is composed of a front inclined portion 17 inclined forward from the receiving-side coupling portion 19 and a rear inclined portion 18 inclined rearward. The rear inclined portion 18 is inclined gently and the front inclined portion 17 is inclined more steeply than the rear inclined portion 18. In this way, the position of the receiving-side coupling portion 19 is near an opening 12 on a front side of the female-side body 11.

As shown in FIG. 3, the bottom wall 21 is a plate and has a locking hole 22 open on a side somewhat rearward of a center. Although not shown, a wire connecting portion project rearward from a rear end of the bottom wall 21. A core of a wire is fixed to the wire connecting portion, and the female terminal 10 and the wire are connected electrically. An unillustrated rubber plug is mounted on the wire and the wire connecting portion is fixed to the rubber plug mounted on the wire.

As shown in FIG. 3, the resilient contact piece 23 includes a first folded portion 25, a second folded portion 29 and an excessive deflection preventing portion 31. The first folded portion 25 is folded rearward from a front end of the bottom wall 21 via a first base part 24. Further, a bead 26 projects up from an upper surface the first folded portion 25. The second folded portion 29 is folded obliquely forward toward the bottom wall 21 from a rear end of the first folded portion 25 via a second base part 28. The excessive deflection preventing portion 31 is bent up at 90° from a front end of the second folded portion 29 via a third base part 30. By providing the excessive deflection preventing portion 31, the resilient contact piece 23 is pressed strongly down, for example, if the male terminal 40 is connected to the female terminal 10 while being drastically inclined. At that time, the tip of the excessive deflection preventing portion 31 butts against the first folded portion 25 to impede a downward displacement of the first folded portion 25. Thus, the resilient contact piece 23 is prevented from being deflected excessively and deformed plastically.

As shown in FIG. 1, the female housing 50 includes a plate-like housing body 51, a female-side receptacle 52 open forward from the housing body 51, a female terminal accommodating portion 53 projecting in the front-rear direction from the housing body 51 and a lock arm 63 provided below the housing body 51.

As shown in FIG. 1, the female terminal accommodating portion 53 has a female-side body accommodating portion 54 forward of the housing body 51 and a rubber plug accommodating portion 61 rearward of the housing body 51. The female-side body accommodating portion 54 and the rubber plug accommodating portion 61 are open in the front-rear direction, and internal spaces of the female-side body accommodating portion 54 and the rubber plug accommodating portion 61 communicate. The female-side body 11 of the female terminal 10 is accommodated in the female-side body accommodating portion 54.

Although not shown, the wire connected to the wire connecting portion of the female terminal 10 is passed through the rubber plug accommodating portion 61, and the rubber plug mounted on the wire is accommodated inside the rubber plug accommodating portion 61.

As shown in FIG. 1, a flexible locking lance 55 rises from an inner lower surface of the female terminal accommodating portion 53 and extends forward. A female terminal locking portion 56 project up from an upper surface of the locking lance 55. The locking lance 55 deflects down as the female-side body 11 is accommodated into the female-side body accommodating portion 54. The female terminal locking portion 56 of the locking lance 55 then is inserted into the locking hole 22 of the female-side body 11. In this way, the female terminal 10 is prevented from coming out rearward. A female-side body support 58 is provided in a front part inside the female terminal accommodating portion 53, and comes into contact with the female-side body 11 to support the female-side body 11. A front wall 59 is provided on front ends of the female-side body accommodating portion 54 and the female-side body support 58. Thus, a front end of the female-side body 11 contacts the front wall 59 if the female terminal 10 is displaced forward to prevent the female terminal 10 from coming out forward from the inside of the female-side body accommodating portion 54. The front wall 59 is provided with a male terminal insertion hole 60 through which the male-side body portion 41 to be described later is to be inserted.

As shown in FIG. 1, the lock arm 63 extends in the front-rear direction. The housing body 51 and the lock arm 63 are coupled via an arm base end 64. The lock arm 63 is flexible and vertically displaceable in a seesaw manner with the arm base end 64 as an axis. A lock portion 66 is provided on a front end part of the lock arm 63.

The male terminal 40 is formed by press-working and bending a metal plate and includes the plate-like male-side body 41, as shown in FIG. 1. A conductivity of the metal plate used for the male terminal 40 generally is set lower than that of the metal plate used for the female terminal 10. The male housing 70 includes an unillustrated male terminal accommodating portion and a male-side receptacle 71 open in a connecting direction of the male terminal 40. A male housing locking portion 72 projects down from the tip of a lower part of the male-side receptacle 71. The male terminal 40 is accommodated in the unillustrated male terminal accommodating portion. The male terminal 40 is accommodated in a somewhat shaky manner in the unillustrated male terminal accommodating portion.

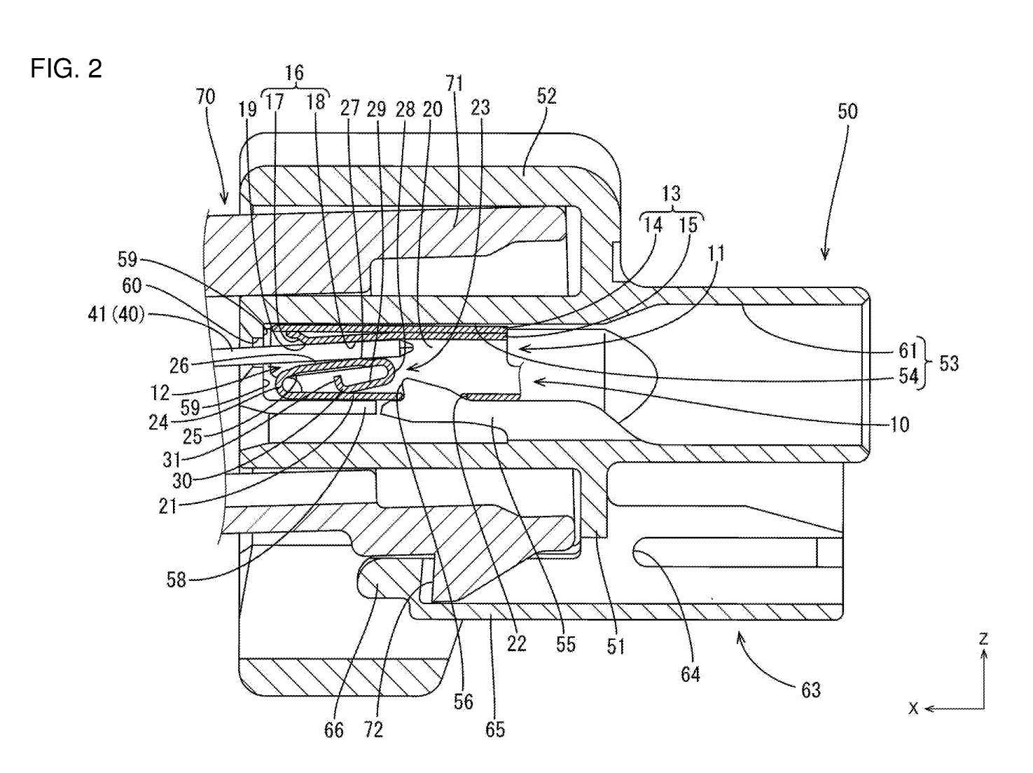

When the female housing 50 and the male housing 70 are connected, the male housing locking portion 72 butts against the lock portion 66 to deflect the lock arm 63 down. The male housing locking portion 72 contacts the lock portion 66 if the male housing 70 is pulled rearward with the connection of the female housing 50 and the male housing 70 completed to prevent the male housing 70 from coming out from the female housing 50. As shown in FIG. 2, a clearance is provided between the male-side receptacle 71 and the female-side receptacle 52. Thus, the male housing 70 is connectable to the female housing 50 even if inclined somewhat.

When the female housing 50 and the male housing 70 are connected and the female terminal 10 and the male terminal 40 are connected, the bead 26 provided on the first folded portion 25 of the resilient contact piece 23 resiliently contacts the male-side body 41 from below, as shown in FIG. 1. By providing the bead 26 in this way, a contact point between the resilient contact piece 23 and the male-side body 41 is determined on the bead portion 26 and a contact point position becomes clear.

The male-side body 41 is resiliently in contact with the receiving-side contact point portions 19 of the parallel left and right receiving portions 16. This causes the female terminal 10 and the male terminal 40 to be in contact at three points, and the female terminal 10 and the male terminal 40 are connected electrically. Since the male-side body 41 is in contact with the two receiving portions 16 at two points in this way, the male-side body 41 is less likely to become shaky in a rotating direction with the connecting direction as an axis in the female-side body 11.

A degree of inclination of the rear inclined portion 18 of the receiving portion 16 of the female terminal 10 is steeper than a maximum inclination of the male-side body 41 when vertical maximum shaking of the male terminal 40 and vertical maximum shaking of the male housing 70 in the female housing 50 are added. By doing so, even if the male-side body portion 41 is inserted in an inclined state into the female-side body 11, as shown in FIG. 2, the male-side body 41 does not contact the female terminal 10 except at the contact point on the bead 26 and the two receiving-side contact points 19, and contact at the three points described above is guaranteed.

Next, functions of the first embodiment are described.

When the male and female housings 70 and 50 are connected, the male-side body 41 of the male terminal 40 is inserted into the female-side body 11 while sliding on the bead 26 of the resilient contact piece 23 of the female terminal 10. When the connection of the male housing 70 and the female terminal 50 is completed, the male-side body 41 resiliently contacts the bead 26 of the resilient contact piece 23, as shown in FIG. 1, thereby resiliently contacting the two receiving-side contacts 19. There are two receiving-side contacts 19, and therefore contact resistance is small as compared to a configuration with one receiving-side contact and resistance between the male and female terminals 40 and 10 is reduced.

Subsequently, when a voltage is applied to the male terminal 40, a current flows from the male-side body 41 to the female-side body 11 through the two receiving-side contacts 19 and the bead 26. The receiving-side contacts 19 are closer to the opening 12 on the front than the contact portion on the bead 26 in the front-rear direction. Thus, a path of a current flowing in the male-side body 41 becomes shorter as compared to a conventional configuration in which a receiving-side contact is closer to an opening on a rear side than a contact point on a bead. Thus, resistance between the male terminal 40 and the female terminal 10 can be reduced since the female-side body 11 has a higher conductivity than the male-side body 41.

Next, it is assumed that the male housing 70 is connected in an inclined state as shown in FIG. 2 when the male housing 70 and the female housing 50 are connected. Also in this case, the male-side body 41 is in contact at three points including the contact point on the bead 26 of the resilient contact piece 23 and the two receiving-side contacts 19. Thus, as in the case where the male housing 70 is connected without being inclined, a path of a current flowing in the male-side body 41 becomes shorter than in the conventional configuration. Therefore, resistance between the male terminal 40 and the female terminal 10 can be reduced.

As described above, the receiving-side contacts 19 are forward of a contact piece-side contact 27 according to the first embodiment. Thus, the path of the current in the male-side body 41 is short as compared to a configuration in which a receiving-side contact point portion is located behind a contact piece-side contact point portion, and resistance between the male terminal 40 and the female terminal 10 can be reduced.

Further, the contact point between the resilient contact piece 23 and the male-side body 41 is determined on the bead 26 and the contact point position becomes clear.

The positions of the receiving-side contacts 19 are on the side of the opening 12. Thus, the path of the current flowing in the male-side body 41 can be made shorter.

There are plural receiving-side contacts 19. Thus, contact resistance between the male terminal 40 and the female terminal 10 can be reduced. Further, by increasing the number of the contact points between the male-side body 41 and the receiving portions 16, the male-side body 41 can be prevented from becoming shaky in the female-side body 11.

### Second Embodiment

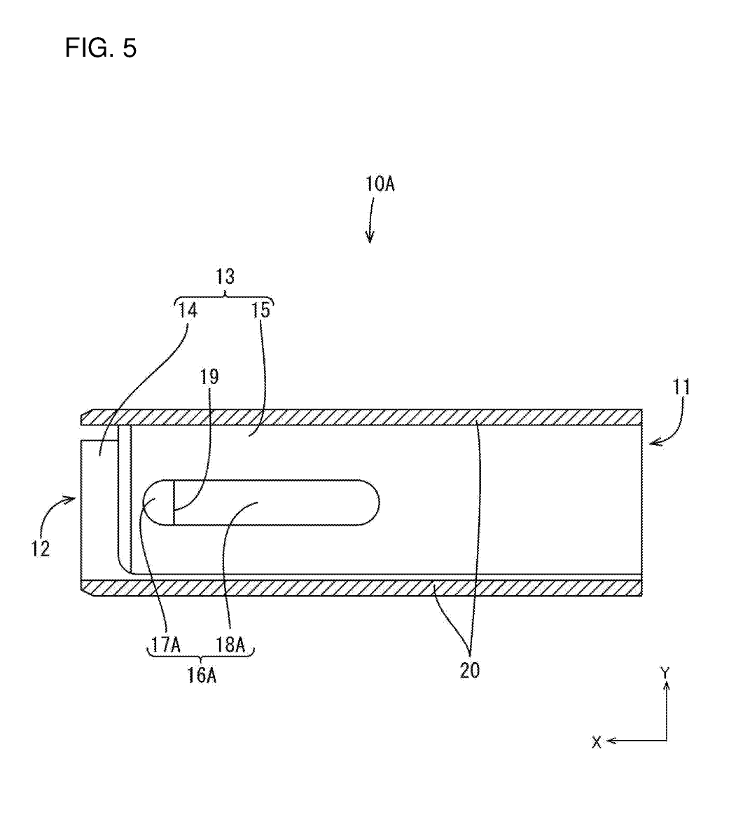

A second embodiment is described with reference to FIG. 5. Although two receiving portions 16 are disposed in the lateral direction in the female terminal 10 of the first embodiment, one receiving portion 16A is provided on a female terminal 10A of the second embodiment, as shown in FIG. 5. As in the first embodiment, the receiving portion 16A includes a front inclined portion 17A and a rear inclined portion 18A. Since there is one contact point between the receiving portion 16A and a male-side body portion 41, contact resistance between the receiving portion 16A and the male-side body portion 41 is larger as compared to the first embodiment. Further, as compared to the first embodiment, the male-side body 41 more easily shakes in a rotating direction with a connecting direction as an axis. The other configuration and functions and effects are the same as in the first embodiment and, hence, not described.

### Third Embodiment

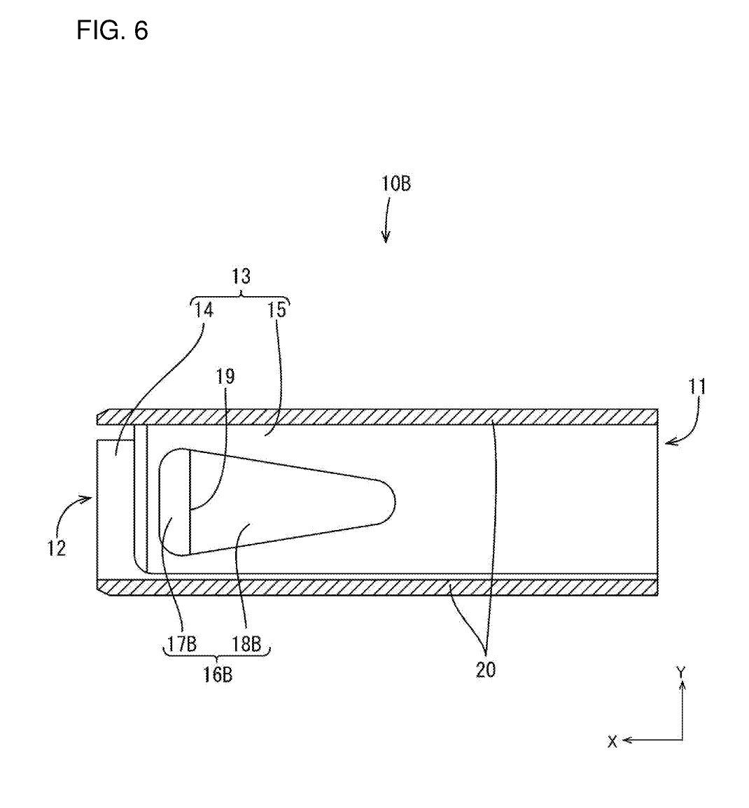

A third embodiment is described with reference to FIG. 6. In a female terminal 10B of the third embodiment, as shown in FIG. 6, there is one receiving portion 16B as in the second embodiment, but the third embodiment differs from the second embodiment in that front ends of a front inclined portion 17B and a rear inclined portion 18B of the receiving portion 16B are long in a lateral direction and a lateral width of the rear inclined portion 18B becomes narrower toward the rear. In this way, the shaking of a male-side body 41 in a rotating direction with a connecting direction as an axis can be suppressed as compared to the second embodiment. The other configuration and functions and effects are the same as in the second embodiment and, hence, not described.

### Fourth Embodiment

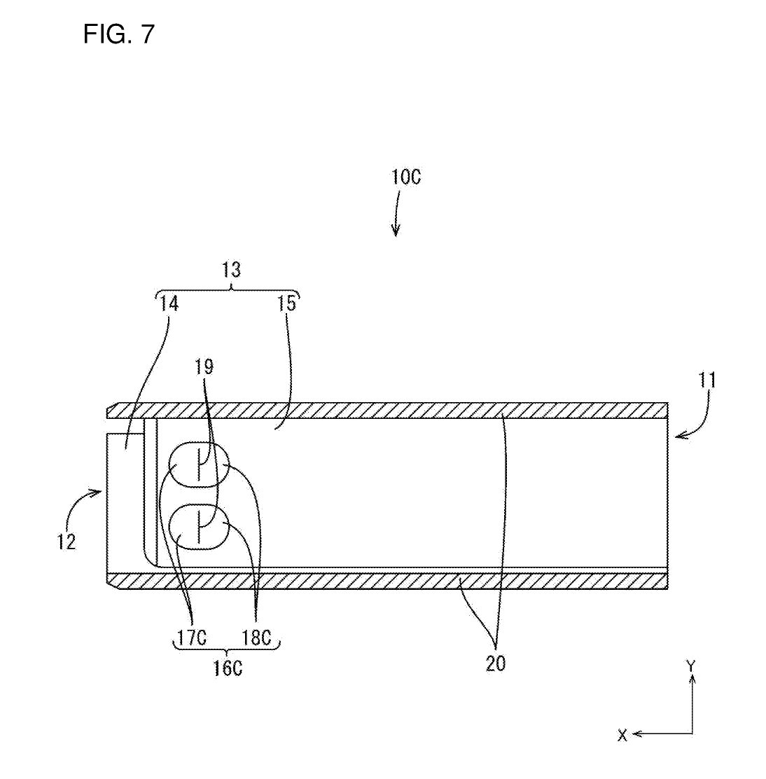

A fourth embodiment is described with reference to FIG. 7. In a female terminal 10C of the fourth embodiment, as shown in FIG. 7, two receiving portions 16C are disposed in parallel in a lateral direction as in the first embodiment, but the fourth embodiment differs from the first embodiment in that a degree of inclination of a rear inclined portion 18C is equal to that of a front inclined portion 17C. The other configuration and functions and effects are the same as in the first embodiment and, hence, not described.

### Reference Example 1

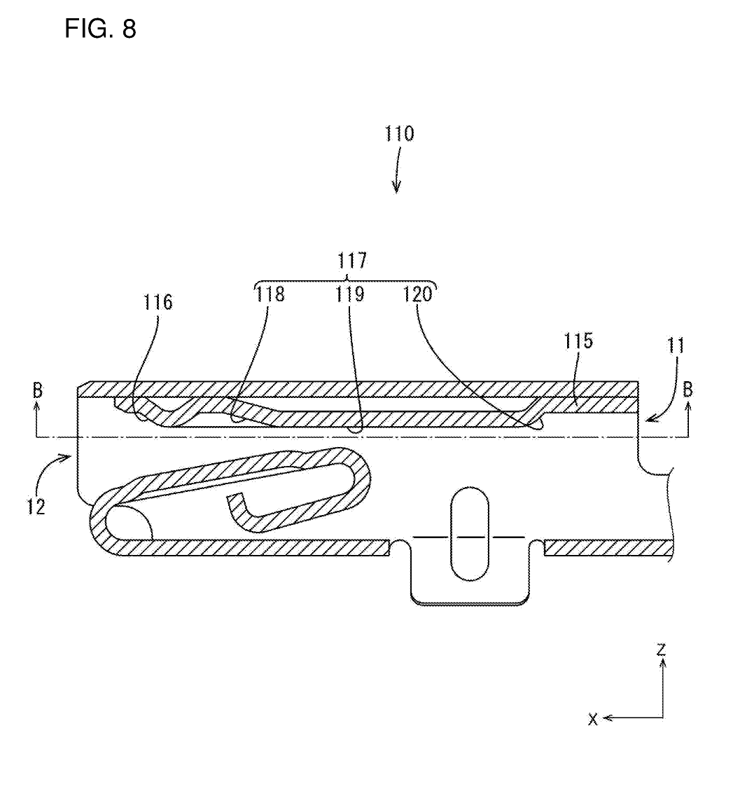

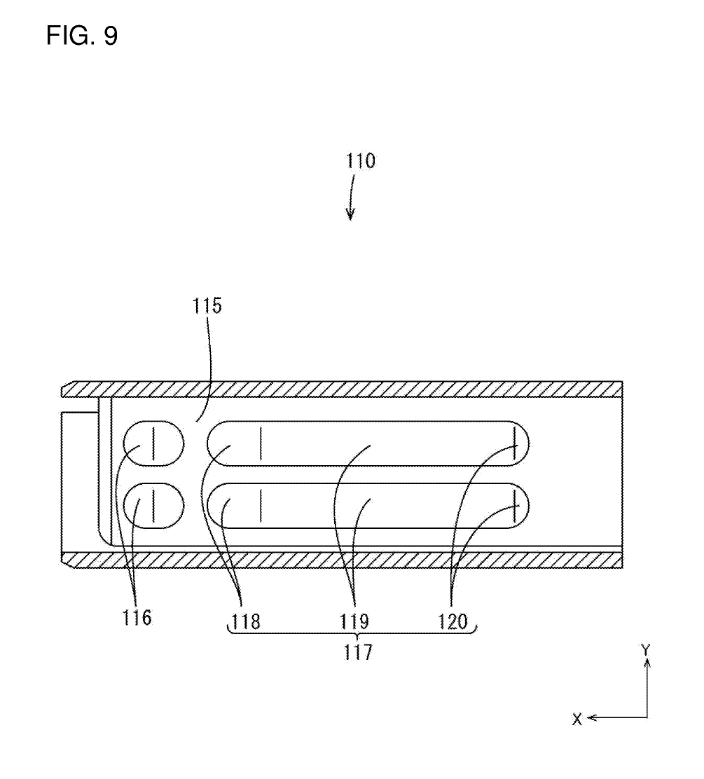

Reference example 1 is described with reference to FIGS. 8 and 9. A female terminal 110 of reference example 1 differs from the first embodiment in the shape of a lower ceiling wall 115, as shown in FIG. 8. The lower ceiling wall 115 includes first receiving portions 116 and second receiving portions 117. The first receiving portions 116 are provided on a side of a female-side body 11 near an opening 12 and project down from a lower surface of the lower ceiling wall 115. The second receiving portions 117 are provided behind the first receiving portion 116 and project down from the lower surface of the lower ceiling wall 115. The first and second receiving portions 116, 117 are spaced apart.

As shown in FIG. 8, the second receiving portion 117 is composed of a flat portion 119, a front inclined portion 118 obliquely inclined forward from a front end of the flat portion 119 and a rear inclined portion 120 obliquely inclined rearward from a rear end of the flat portion 119. As shown in FIG. 9, two first receiving portions 116 and two second receiving portions 117 are disposed in parallel in a lateral direction. The other configuration is the same as in the first embodiment and, hence, not described.

Next, functions of reference example 1 are described. Although not shown, when a male terminal 40 and the female terminal 110 are connected, a male-side body 41 resiliently contacts a bead 26 of a resilient contact piece 23, thereby resiliently contacting tops of the first receiving portions 116 and surfaces of the flat portions 119 of the second receiving portions 117. Since the flat portions 119 are provided in this way, even if the male terminal 40 shakes due to vibration or the like, the male-side body 41 butts against the flat portions 119, and the vibration of the male terminal 40 is absorbed by the female terminal 110. In this way, the female terminal 110 is configured to resist vibration and the like as compared to the female terminal 10 of the first embodiment. However, if the male-side body 41 and the first receiving portions 116 are no longer in contact due to vibration or the like, there are only two contact points at the bead 26 and the surfaces of the flat portions 119, and a path of a current flowing in the male-side body 41 becomes longer. Thus, resistance between the male terminal 40 and the female terminal 110 increases. Other functions and effects are the same as in the first embodiment and, hence, not described.

### Reference Example 2

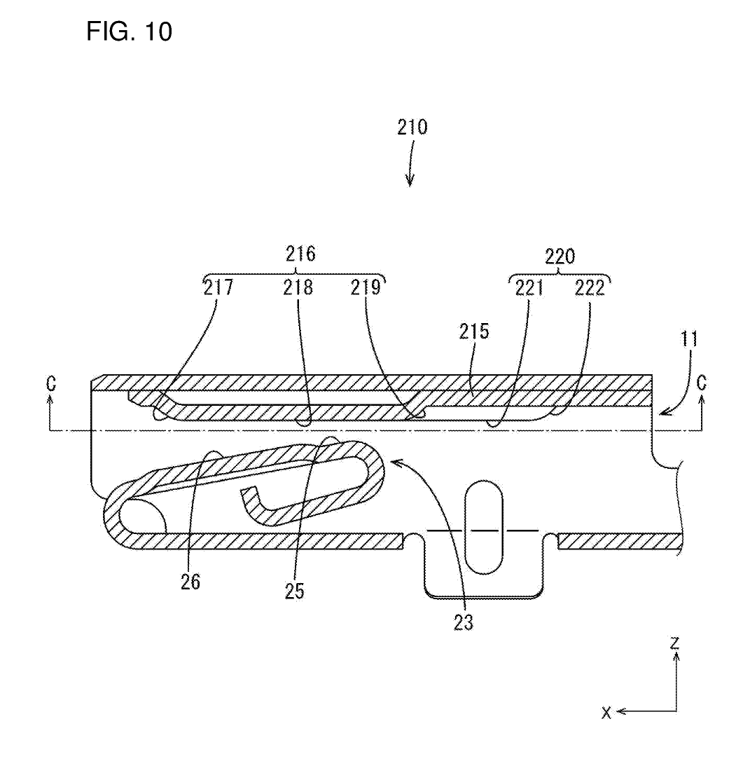

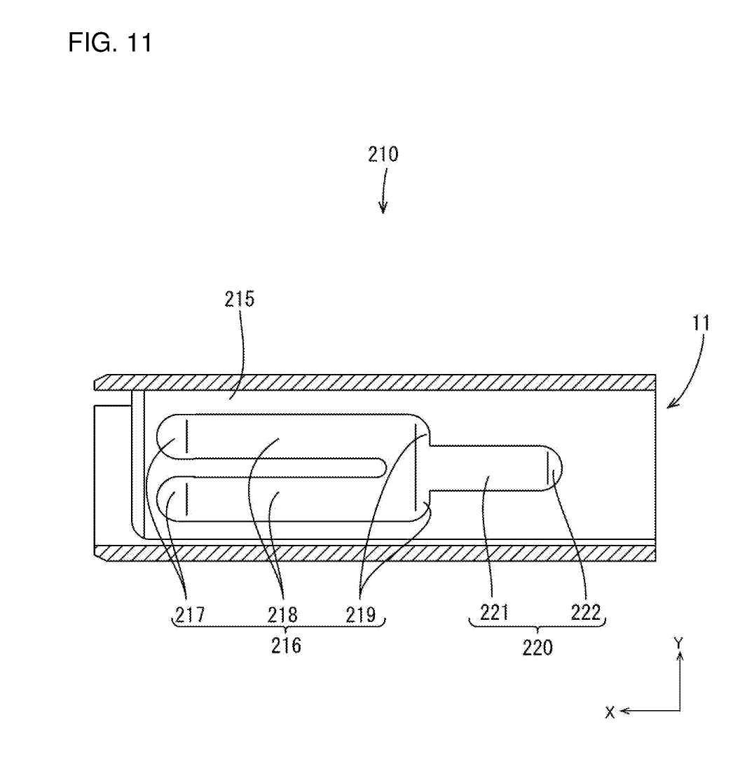

Reference example 2 is described with reference to FIGS. 10 and 11. A female terminal 210 of reference example 2 differs from the first embodiment in the shape of a lower ceiling wall 215 as shown in FIGS. 10 and 11.

The lower ceiling wall 215 includes first receiving portions 216 and a second receiving portion 220. The first receiving portion 216 is located on a front side of the lower ceiling wall 215 and projects down from a lower surface of the lower ceiling wall 215. The first receiving portion 216 is composed of a first flat portion 218, a first front inclined portion 217 obliquely inclined forward from a front end of the first flat portion 218 and a first rear inclined portion 219 obliquely inclined rearward from a rear end of the first flat portion 218.

The second receiving portion 220 is located on a rear side of the lower ceiling wall 215 and projects down from the lower surface of the lower ceiling wall 215. The second receiving portion 220 is composed of a second flat portion 221 shaped to be flat and a second rear inclined portion 222 obliquely inclined rearward from a rear end of the second flat portion 221. As shown in FIG. 11, two first receiving portions 216 are disposed in parallel in a lateral direction, and the second receiving portion 220 is located in a lateral center of the lower ceiling wall 215. Rear ends of the two first receiving portions and a front end of the second receiving portion 220 are connected. The other configuration is the same as in the first embodiment and, hence, not described.

Although not shown, when a male terminal 40 and the female terminal 210 are connected, a male-side body 41 resiliently contacts a bead 26 of a resilient contact piece 23, thereby resiliently contacting surfaces of the two first flat portions 218 and a surface of the second flat portion 221. Since the second flat portion 221 is provided in this way, even if the male terminal 40 shakes due to vibration or the like, the male-side body 41 butts against the second flat portion 221 so that the vibration of the male terminal 40 is absorbed by the female terminal 210. In this way, the female terminal 210 is configured to be resistant to vibration and the like as compared to the female terminal 10 of the first embodiment. However, if the male-side body 41 and the first receiving portions 218 are no longer in contact due to vibration or the like, there are only two contact points at the bead 26 and the surface of the second flat portion 221 and a path of a current flowing in the male-side body portion 41 becomes longer. Thus, resistance between the male terminal 40 and the female terminal 210 increases. The other functions and effects are the same as in the first embodiment and, hence, not described.

The invention described by this specification is not limited to the above described and illustrated embodiments. For example, the following various modes are also included.

Although two receiving portions 16, 16C are provided in the first and fourth embodiments and one receiving portion 16A, 16B is provided in the second and third embodiments, the number of receiving portions may be three or more.

Although the receiving portions 16, 16A to 16C are provided on the side of the ceiling wall 13 and the resilient contact piece 23 is provided on the side of the bottom wall 21 in the first to fourth embodiments, receiving portions may be provided on a bottom wall and a resilient contact piece may be provided on a ceiling wall. Further, receiving portions may be provided on one side wall side and a resilient contact piece may be provided on the other side wall.

Although the resilient contact piece 23 is provided with the bead 26 in the first to fourth embodiments, the bead portion 26 may not be provided.

Although the wire connecting portion projects rearward from the rear end of the bottom wall 21 in the first to fourth embodiments, a wire connecting portion may project rearward from a ceiling wall or a side wall.

### LIST OF REFERENCE SIGNS

10 . . . female terminal
11 . . . female-side body
12 . . . opening
16 . . . receiving portion
17 . . . front inclined portion
18 . . . rear inclined portion
19 . . . receiving-side contact point portion
23 . . . resilient contact piece
25 . . . first folded portion (folded portion)
26 . . . bead
27 . . . contact piece-side contact point portion
40 . . . male terminal
41 . . . male-side body

What is claimed is:

1. A female terminal (10) to be connected to a male terminal (40) including a male-side body (41) extending in a front-rear direction, comprising:
a female-side body (11) configured so that the male-side body (41) is inserted therein from a front;
a resilient contact piece (23) configured to resiliently contact the male-side body (41) in a first direction intersecting a connecting direction to the male terminal (40); and
a receiving portion (16) configured to contact the male-side body (41) in a second direction opposite to the first direction;
a receiving-side contact (19) located forward of a contact piece-side contact (27) and defining a contact point between the receiving portion (16) and the male-side body (41) thereby defining as a contact location between the resilient contact piece (23) and the male-side body (41).

2. The female terminal of claim 1, wherein:
the female-side body (11) includes an opening (12), the male-side body (41) being inserted through the opening;
the resilient contact piece (23) includes a folded portion (25) cantilevered from a front edge of the opening (12) and folded rearward;
the folded portion (25) is provided with a bead (26) projecting in the second direction; and
the contact piece-side contact (27) is provided on the bead (26).

3. The female terminal of claim 2, wherein:
the receiving portion (16) includes a front inclined portion (17) having a chevron shape projecting in the first direction, located forward of the receiving-side contact (27) serving as a top and inclined in the second direction, and a rear inclined portion (18) located on a rear side and inclined in the second direction;
the front inclined portion (17) is inclined more steeply than the rear inclined portion (18) and the receiving-side contact (27) is provided on the opening side of the female-side body (11).

4. The female terminal of claim 3, wherein plural of the receiving portions (16) are disposed in parallel in a width direction in the female-side body (11).

5. The female terminal of claim 1, wherein:
the receiving portion (16) includes a front inclined portion (17) having a chevron shape projecting in the first direction, located forward of the receiving-side contact (27) serving as a top and inclined in the second direction, and a rear inclined portion (18) located on a rear side and inclined in the second direction;
the front inclined portion (17) is inclined more steeply than the rear inclined portion (18) and the receiving-side contact (27) is provided on the opening side of the female-side body (11).

6. The female terminal of claim 5, wherein plural of the receiving portions (16) are disposed in parallel in a width direction in the female-side body (11).

7. The female terminal of claim 1, wherein plural of the receiving portions (16) are disposed in parallel in a width direction in the female-side body (11).
